(19) United States
(12) Patent Application Publication
(10) Pub. No.: US 2013/0242313 A1
(43) Pub. Date: Sep. 19, 2013

(54) SCANNING METHODS AND APPARATUS

(71) Applicants: Peter Tomlins, London (GB); Oluyori Kutulola Adegun, London (GB); Farida Fortune, London (GB)

(72) Inventors: Peter Tomlins, London (GB); Oluyori Kutulola Adegun, London (GB); Farida Fortune, London (GB)

(21) Appl. No.: 13/883,416

(22) PCT Filed: Nov. 4, 2011
(86) PCT No.: PCT/GB2011/001559

§ 371 Date: May 3, 2013

(30) Foreign Application Priority Data
Nov. 5, 2010 (GB) 1018743.3

(51) Int. Cl. G01N 21/17

(52) U.S. Cl. CPC G01N 21/17
USPC 356/497

(57) ABSTRACT

There is provided a method of identifying a region of interest in sample. The method comprises obtaining one or more optical coherence tomography (OCT) axial scans at one or more locations over the sample surface; for each axial scan, determining an integrated total of OCT intensity over the depth of the scan, and determining an attenuation depth into the sample at which a predetermined fraction of the integrated total is reached; and determining the from the one or more attenuation depths a region of interest in the sample. Generally, the method does not rely the accuracy (or inaccuracy) of any particular scientific model of scattering and attenuation. It is therefore robust and can be employed across a wide variety of samples, including non-biological ones.

### FIELD OF THE INVENTION

The present invention relates to the field of optical coherence tomography, and LO particularly to methods and apparatus using optical coherence tomography to identify a region of interest in a sample.

### BACKGROUND ART

Obtaining an accurate histopathological diagnosis for oral epithelial dysplasia (OED) is dependent on the selection of the most representative site to biopsy. Today, identification of these sites can be a challenging procedure owing to the considerable variations in the clinical appearances of lesional and non-lesional locations. To facilitate improved localisation of biopsy sites, techniques have been introduced for visualising structural and metabolic alterations not revealed during clinical examinations. Such techniques include topical application of optical contrast agents, such as toluidine blue, direct visualisation of tissue fluorescence and direct oral microscopy.

Although these approaches have reported improved detection of abnormal areas, they remain limited by their dependence on static and qualitative assessment of disease sites. To obviate some of these issues, optical coherence tomography (OCT) has been considered. OCT is an emerging non-invasive imaging modality capable of producing quantitative assessment of tissue properties. For in vivo clinical evaluation of tissue it provides promising attributes, such as acquisition speed, imaging depth, micrometer scale resolution and three-dimensional sampling ability. However, it lacks the resolution to provide subcellular detail necessary for the interpretation of conventional histopathology images. Despite this, OCT has been used in vivo to study oral dysplasia and malignancy in humans, with reported differentiation of normal, dysplastic and squamous cell carcinoma of the oral mucosa. These studies have identified the potential of OCT to provide early detection and regular monitoring of suspect lesions in the oral cavity. However, the lack of sub-cellular detail in OCT and dependence upon subjective visual evaluation limits the absolute diagnostic efficacy.

### SUMMARY OF THE INVENTION

The present invention seeks to address these and other issues.

In one aspect, there is provided a method of identifying a region of interest in sample. The method comprises obtaining one or more optical coherence tomography (OCT) axial scans at one or more locations over the sample surface; for each axial scan, determining an integrated total of OCT intensity over the depth of the scan, and determining an attenuation depth into the sample at which a predetermined fraction of the integrated total is reached; and determining from the one or more attenuation depths a region of interest in the sample.

The present invention thus employs OCT techniques to rapidly identify regions of interest within a sample. Generally, the method relies upon measurement of OCT data and integration of that data using simple mathematical techniques. The method does not rely upon the accuracy (or inaccuracy) of any particular scientific model of scattering and attenuation. It is therefore robust and can be employed across a wide variety of samples, including non-biological ones.

### BRIEF DESCRIPTION OF THE DRAWINGS

An embodiment of the present invention will now be described by way of example, with reference to the accompanying figures in which;

FIG. 1 shows an apparatus according to embodiments of the present invention;

FIG. 2 shows a typical a-scan;

FIG. 3 is a flow chart of a method of identifying a region of interest in a sample according to embodiments of the present invention; and

FIG. 4 is a flow chart of a method of calibrating an apparatus according to embodiments of the present invention.

### DETAILED DESCRIPTION OF THE EMBODIMENTS

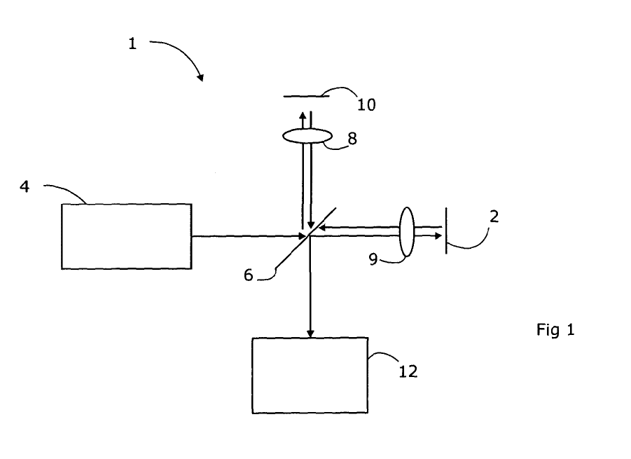

FIG. 1 is a schematic illustration showing an optical coherence tomography (OCT) system 1 according to embodiments of the present invention. In the illustration, the system 1 is being employed to analyse a sample 2. The sample may be animal or human tissue, or a non-biological tissue such as a polymer composite (for example).

The system comprises a source 4 of broadband light, which is directed towards an interferometer. In the illustrated embodiment, a Michelson interferometer is employed, but alternatives may be employed by those skilled in the art without departing from the scope of the invention. The interferometer comprises references and sample optical paths. So, the light from the broadband source 4 is incident on a beam splitter 6, which splits the light into a first component directed along the reference path, and a second component directed along the sample path.

The light reflected along the sample path is focused by a lens 9 towards the sample 2. Some of the light is backscattered from the sample 2 towards the lens 9 and the beam splitter 6.

The light reflected along the reference path is focused by a lens 8 towards a reference mirror 10. The light reflects off the mirror, through the lens 8 and towards the splitter 6, where it recombines with the light backscattered from the sample 2. A portion of this recombined light is reflected towards the light source 4, where it is lost. Another portion is reflected towards a photodiode and analysis circuitry 12. The mirror 10 can be moved to lengthen or shorten the reference path, and so analyse different components of the scattered light. Alternatively, spectral detection followed by Fourier transform of the fringes may be employed to analyse the data.

The interferometer is capable of measuring the optical intensity at various three-dimensional locations in the sample. The convention used herein is that (x, y) co-ordinates represent the longitudinal and latitudinal directions, i.e. movement over the surface of the sample, and the z co-ordinate represents depth into the sample.

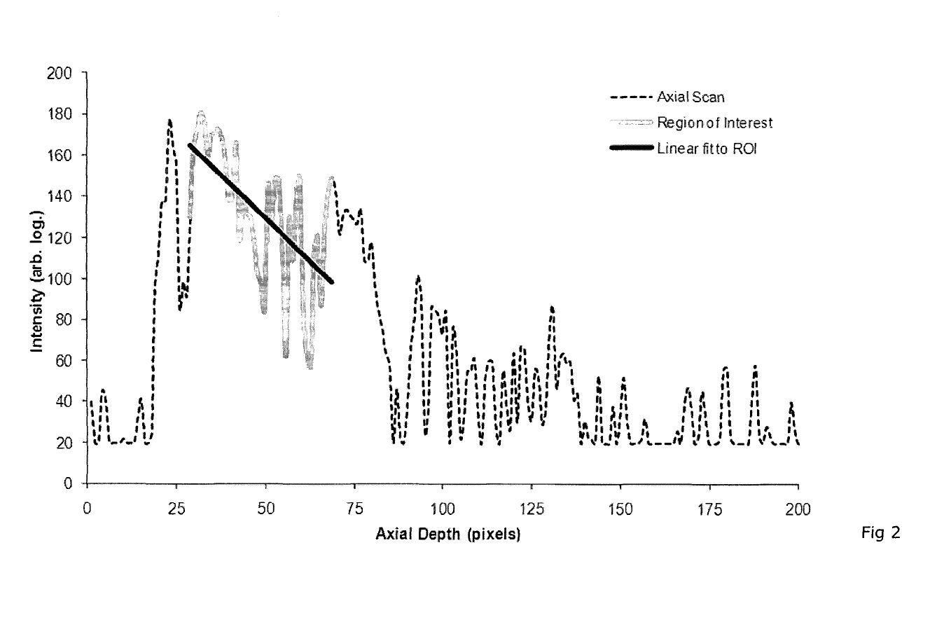

In its normal mode of operation, the system 1 is arranged to obtain a plurality of axial scans (a-scans); that is, scans of the optical intensity for a particular (x, y) location as a function of depth, z. An example of a typical a-scan is shown in FIG. 2.

The attenuation of light in a sample is a good indicator of the type of sample being investigated. For example, different types of biological tissue will have different attenuation properties, as will different types of non-biological material. In the biological world, OCT attenuation data may be used to detect dysplastic regions (as discussed above), or other differences between tissue types in a single sample. In industry, OCT attenuation data may be used to detect flaws in materials.

OCT images are typically formed on a logarithmic intensity scale I_{log}(z)=20log[I(z)], expressed in decibels (dB), where I(z) is the measured intensity. For visualization, the logarithmic intensity is mapped to an 8-bit greyscale,

$$\begin{matrix}{I}_{8 bit} ( z ) = 255 \frac{{I}_{log} ( z ) - {I}_{min}}{{I}_{max} - {I}_{min}} , \\ where & ( 1 ) \\ {I}_{log} ( z ) = \{ \begin{matrix}{I}_{log} ( z ) , & {I}_{min} \leq {I}_{log} ( z ) \leq {I}_{max} \\ {I}_{min} , & {I}_{min} > {I}_{log} ( z ) \\ {I}_{max} , & {I}_{log} ( z ) > {I}_{max} .\end{matrix} & ( 2 )\end{matrix}$$

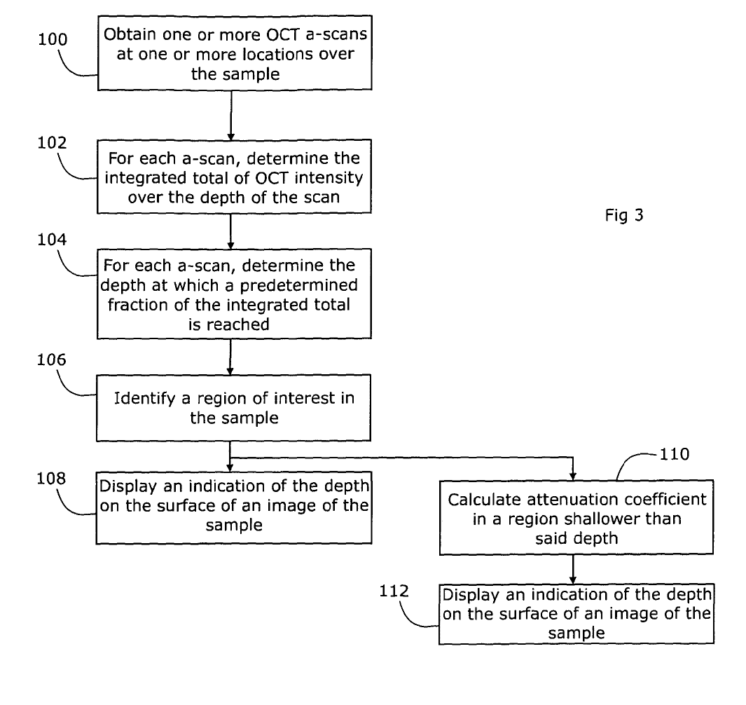

FIG. 3 is a flow chart of a method according to embodiments of the present invention.

The method begins in step 100, where one or more OCT a-scans are obtained at one or more respective locations over the sample. As previously described, an a-scan is a measurement of optical intensity for a particular location (x, y) as a function of depth z.

For each a-scan, the optical intensity is integrated over the whole depth of the scan (step 102). The integrated optical intensity from the surface to a depth z_{b} is given by

$${I}_{b} ( {z}_{b} ) = {\int }_{0}^{{z}_{b}} {I}_{log} ( z ) d z . \qquad ( 3 )$$

The integral from the sample surface over the whole depth is assumed to represent 100% of the backscattered light component, I_{T}, detected by the OCT instrument 10 along a single a-scan. This ignores both light scattered outside of the OCT system numerical aperture and absorption of light within the sample.

I_{T}=I_{b} (∞). (4)

For each a-scan, the analysis circuitry 12 determines the attenuation depth zₐₜₜ at which a certain fraction a of the integrated total has been backscattered (step 104), where 0<a<1. That fraction may be calibrated in accordance with embodiments of the present invention as described below. So, the attenuation depth is calculated using the following equation:

$$I ( {z}_{att} ) = α {I}_{T} = {\int }_{0}^{{z}_{att}} {I}_{log} ( z ) d z \qquad ( 5 )$$

a is kept constant for the a-scans in all locations, and therefore zₐₜₜ varies between a-scans.

This information may be used in various ways.

According to embodiments of the present invention, the attenuation depth zₐₜₜ provides an indication of a region of interest in the sample (step 106), i.e. a part of the depth profile having particular optical properties. For example, the attenuation depth zₐₜₜ may define the lower limit of the region of interest (the upper limit equivalent to the surface of the sample). This is shown in FIG. 2, where the region of interest is identified in a single a-scan, with zₐₜₜ as the lower limit at approximately 70 pixels. Multiple regions of interest in adjacent a-scans may be used to identify a region of interest in a cross-section of the sample, i.e. a particular layer of the sample.

The attenuation depth zₐₜₜ may also be used to identify the surface of the sample, by setting the fraction a of integrated light intensity relatively low. In practice this may result in a depth slightly below the actual surface of the sample, but that is still useful.

It will also be apparent to those skilled in the art that multiple attenuation depths may be calculated for the same a-scan, using different values of a. This would allow upper and lower boundaries of a region of interest to be identified, for example.

According to one embodiment, the attenuation depth zₐₜₜ is plotted as a two-dimensional “en face” map over an image of the sample (step 108). So, for example, for each (x, y) position on the surface of the sample, the attenuation depth zₐₜₜ for that position is illustrated. A colour scale may be used to illustrate this most effectively. Such a map clearly illustrates areas of the sample having different attenuation properties, allowing a user to determine faults in a non-biological sample, or areas to biopsy in a biological tissue (for example).

In an alternative embodiment, the attenuation depth zₐₜₜ may be used as an aid to more effectively measure the attenuation coefficient μ_{T} in a region of interest.

The OCT a-scan signal I(z) from a homogeneous scattering medium can be described as a function of depth z as shown by Eq. 6. This is valid in the limit of single scattering.

I(z)I₀Kμ_{b}A(z)exp(−2μ_{T}z). (6)

The signal decreases exponentially with depth at a rate determined by the total attenuation coefficient μ_{T}.

μ_{T}=μₐ+μₛ. (7)

This combines the effects of both scattering μₛ and absorption μₐ. The function A(z) describes the depth dependency of the backscattered signal amplitude. This arises from two primary sources, namely the light capture efficiency of the optical system that varies throughout the focused probe beam and detection sensitivity. Depth dependency of the sensitivity in a frequency domain detection system is due to the finite sampling bandwidth of a discretely sampled source spectrum.

The constant amplitude coefficients I₀, μ_{b} and K represent respectively the optical intensity at the surface, the backscattering coefficient and a scale factor accounting for distribution of the detected intensity over the source coherence length.

Substituting from Eq. 6 into Eq. 7, the OCT image intensity is

$${I}_{8 bit} ( z ) = ɛ ln [ {I}_{0} K {μ}_{b} A ( z ) ] - ɛ {μ}_{T} z - 255 \frac{{I}_{min}}{{I}_{max} - {I}_{min}} , \qquad ( 8 )$$

with the coefficient ε defined as

$$ɛ = \frac{255}{{I}_{max} - {I}_{min}} \frac{20}{ln ( 10 )} . \qquad ( 9 )$$

From Eq. 8 it is evident that the effects of A(z) can be subtracted from the image, leaving an expression for a straight line with a gradient

$$\frac{d }{d z} {I}_{ 8 bit} ( z ) = - {ɛμ}_{T} . \qquad ( 10 )$$

Therefore, absolute measurement of μ_{T} depends upon calibration of A(z) and knowledge of Iₘₐₓ and Iₘᵢₙ, or access to the raw data. However, without this information it is still possible to make relative measurements of μ_{T} directly from OCT images.

At tissue depths greater than μₛ⁻¹ multiple scattering begins to dominate and Eq. 6 is no longer a valid model. For human oral epithelium, for example, μₛ⁻¹ is typically of the order 0.5 mm, which is greater than its predicted thickness. The analysis should be focused within the epithelial tissues where the changes of interest are located. Thus, a can be chosen so that the attenuation depth zₐₜₜ roughly corresponds to the bottom of the epithelial layer.

In step 110, therefore, the gradient of the optical intensity

$$\frac{d {I}_{8 bit} ( z )}{d z}$$

is measured in a region shallower than the attenuation depth zₐₜₜ (i.e. a region of interest), giving an estimate of the attenuation coefficient μ_{T}. FIG. 2 shows one example of this, where the gradient is measured in a region shallower than around 75 pixels.

In step 112, this attenuation coefficient may be displayed as a two-dimensional “en face” map over an image of the sample. So, for example, for each (x, y) position on the surface of the sample, the attenuation coefficient μ_{T} for that position is illustrated. A colour scale may be used to illustrate this most effectively.

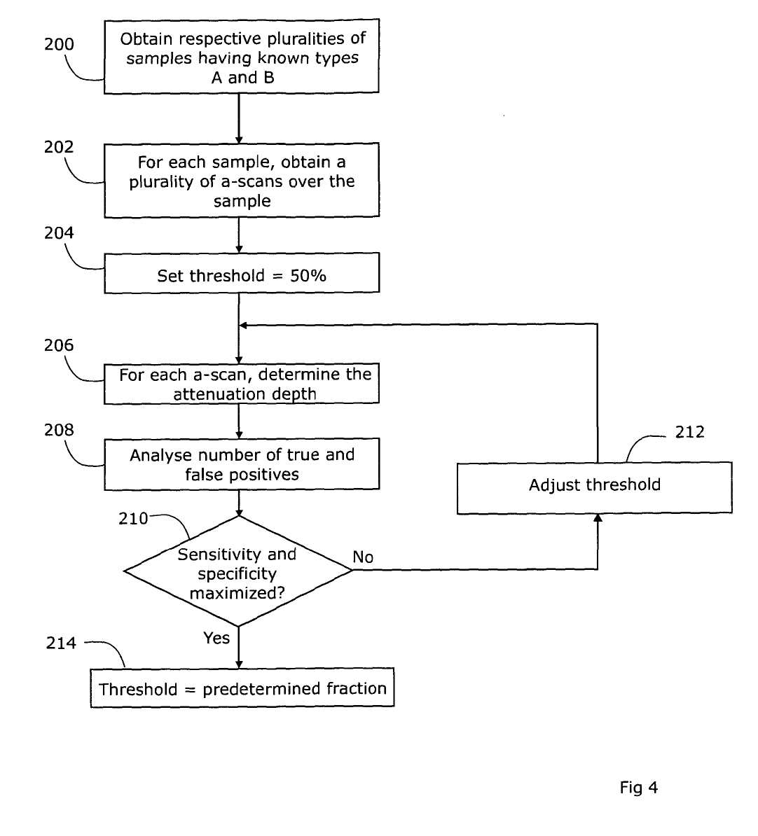

The present invention therefore provides new methods and apparatus for identifying regions of interest in a sample, whether that sample is biological or non-biological. In its most general form, the invention does not rely on any particular scientific model, and is therefore robust regardless of the sample material. However, it is necessary to select the threshold a appropriately, i.e. so that the system is correctly calibrated to distinguish between different types of a particular tissue or material. One method of calibration is shown as a flow chart in FIG. 4.

The method begins in step 200, where a number of samples are collected. Multiple samples of the material to be tested are obtained, each belonging to one of the two classification groups between which it is desired to discriminate. These are labelled, one as the positive group, the other the negative group (or types “A” and “B” in FIG. 4). The classification must be known a priori.

In step 202, OCT a-scans are acquired from each sample. In an embodiment, the same number of a-scans is obtained from each sample.

In step 204, the threshold a is set at an arbitrary value, i.e. a “first guess”. In the illustrated embodiment that is 50%, but alternative values could be used by those skilled in the art without departing from the scope of the invention.

In step 206, the attenuation depth is calculated for each a-scan, and this data is analysed in step 208. For example, histograms of the attenuation depth can be calculated for each group. As the true nature of the sample under test is known, the attenuation depth data can be analysed to see whether it discriminates between the two types.

True positives (TP) are defined as the total number of attenuation depth values measured from the positive group that fall within the positive classification. False positives (FP) are defined as the total number of attenuation depth values measured from the negative group that also fall within the positive classification. The true positive rate (TPR) is defined as the ratio of TP to the total number of attenuation depth measurements in the positive group. The false positive rate (FPR) is defined as the ratio of FP to the total number of attenuation depth measurements in the negative group. “Sensitivity” is equal to the TPR, and “specificity” is equal to 1−FPR.

The goal of the process is to maximize the sensitivity and specificity. Thus it may be necessary to repeat steps 206 and 208 for different values of a, before it can be determined whether those quantities are maximized for a particular value of a. Nevertheless, in step 210 it is decided whether sensitivity and specificity are maximized, i.e. whether they are acceptable. If not, the value of a is adjusted (step 212), and steps 206 to 210 repeated. If those quantities are maximized using the selected value of a, that value can be used in the method shown in FIG. 3. Of course, multiple values of a can be used in the same a-scan to identify upper and lower regions of interest in the sample (for example).

The present invention thus provides methods and apparatus for scanning a sample and identifying a region of interest within that sample. Embodiments of the present invention are robust in that they do not rely on any particular scientific model of the analysed sample, and can thus be employed in a variety of medical and industrial situations.

It will of course be understood that many variations may be made to the above-described embodiment without departing from the scope of the present invention.

1. A method of identifying a region of interest in a sample, comprising:
obtaining one or more optical coherence tomography (OCT) axial scans at one or more locations over the sample surface;
for each axial scan, determining an integrated total of OCT intensity over the depth of the scan, and determining an attenuation depth into the sample at which a predetermined fraction of the integrated total is reached; and
determining from the one or more attenuation depths a region of interest in the sample.

2. The method as claimed in claim 1, further comprising:
generating an image of said sample, in which an indication of said attenuation depth is displayed at each respective location on the sample surface.

3. The method as claimed in claim 2, wherein the attenuation depth is indicated by a colour.

4. The method as claimed in claim 1, further comprising:
for each axial scan, determining an attenuation coefficient by measuring a gradient of the OCT intensity in a region shallower than said attenuation depth.

5. The method as claimed in claim 4, further comprising:
generating an image of said sample, in which an indication of said attenuation coefficient is displayed at each respective location on the sample surface.

6. The method as claimed in claim 5, wherein the attenuation coefficient is indicated by a colour.

7. The method as claimed in any one of the preceding claims, wherein the sample is of tissue from the human or animal body.

8. An optical coherence tomography (OCT) system for scanning a sample, comprising:
a source of broadband light, generating broadband light which is incident on the sample;
an interferometer, for detecting the light scattered from the sample and collating OCT data; and
analysis circuitry, arranged to:
analyse the OCT data to obtain one or more OCT axial scans at one or more locations over the sample surface; and
for each axial scan, determine an integrated total of OCT intensity over the depth of the scan, and determine an attenuation depth into the sample at which a predetermined fraction of the integrated total is reached.

9. The OCT system as claimed in claim 8, further comprising:
a display, for showing an image of said sample in which an indication of said attenuation depth is displayed at each respective location on the sample surface.

10. The OCT system as claimed in claim 9, wherein the attenuation depth is indicated by a colour.

11. The OCT system as claimed in claim 8, wherein the analysis circuitry is further arranged to:
for each axial scan, determine an attenuation coefficient by measuring a gradient of the OCT intensity in a region shallower than said attenuation depth.

12. The OCT system as claimed in claim 11, further comprising:
a display, for showing an image of said sample in which an indication of said attenuation coefficient is displayed at each respective location on the sample surface.

13. The OCT system as claimed in claim 12, wherein the attenuation coefficient is indicated by a colour.

14. A method of identifying a region of interest in a sample substantially as herein described with reference to and/or as illustrated in the accompanying drawings.

15. An optical coherence tomography system substantially as herein described with reference to and/or as illustrated in the accompanying drawings.
